(19) United States
(12) Patent Application Publication
(10) Pub. No.: US 2007/0089613 A1
(43) Pub. Date: Apr. 26, 2007

(54) Pusher for juice extruders

(76) Inventor: Li-Chen Wu Chang, Taoyuan Hsien (TW)

Correspondence Address: LIN & ASSOCIATES INTELLECTUAL PROPERTY, P.O. BOX 2339, SARATOGA, CA, 95070-0339, US

(21) Appl. No.: 11/256,236

(22) Filed: Oct. 21, 2005

(51) Int. Cl. A47J 43/14

(52) U.S. Cl. 99/495

(57) ABSTRACT

A pusher of a juice extruder includes a first part and a second part, wherein the first part is connected to an inner periphery of the inlet of the extruder and a lower end of the first part is located close to a center of the blade set of the extruder so that fruit can be fed away from the center of the blade set. The second part occupies the rest space of the inlet and push fruit toward the blade set. The fruit is located away from the center of the blade set so that the motor of the extruder is not locked.

### FIELD OF THE INVENTION

The present invention relates to a pusher of a juice extruder and includes two parts to keep the fruit located off from the center of the blades.

### BACKGROUND OF THE INVENTION

A conventional juice extruder is disclosed in FIG. 7 and generally includes a motor for driving blades 12 and an inlet is defined in a top of the case of the juice extruder so that fruit is fed into the extruder from the inlet. A pusher “A” is inserted into the inlet to push the fruit toward the blades 12 to be ground and the juice is collected from a spout on a side of the juice extruder. Generally the blades are circular plates with teeth defined on at op thereof and the inlet is located corresponding to a center of the blades, so that the fruit is located at the center of the blades and cannot be ground and the motor is easily locked.

The present invention intends to provide a pusher for a juice extruder and includes two parts wherein one part is connected to an inner circular periphery of the inlet and the second part movably occupies the rest of the space in the inlet so as to keep the fruit off from the center of the blades to improve the shortcomings of the conventional juice extruders.

### SUMMARY OF THE INVENTION

The present invention relates to a pusher of a juice extruder and the pusher includes a first part connected to an inner periphery of the inlet of the juice extruder and a second part which has a part of an outer periphery thereof being shaped to be complimentary to a part of an outer periphery of the first part. The second part is movably inserted into the inlet.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the pusher of the present invention and a juice extruder;

FIG. 2 is an exploded view to show the shows the pusher of the present invention;

FIG. 3 shows the second part of the pusher of the present invention;

FIG. 4 shows that the second part is to be inserted into the inlet in which the first part is connected thereto;

FIG. 5 is a cross sectional view to show that the second part is to be inserted into the inlet in which the first part is connected thereto;

FIG. 6 shows that fruit is pushed by the second part of the pusher, and

FIG. 7 shows a conventional pusher and a juice extruder.

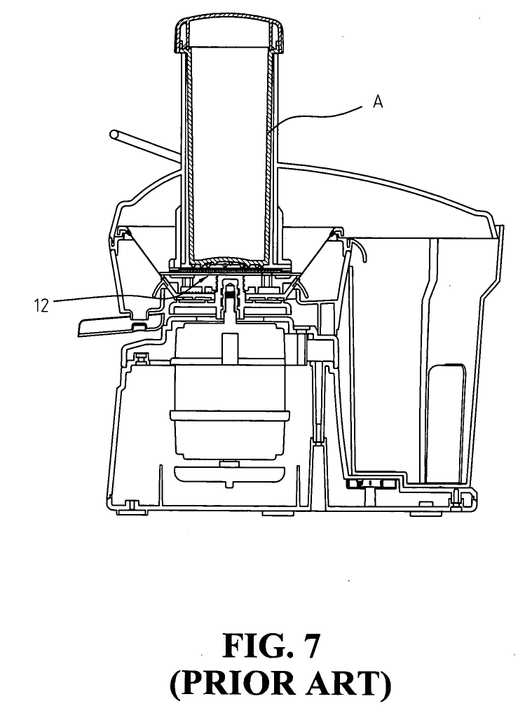

### DETAILED DESCRIPTION OF THE PREFERRED EMBODIMENT

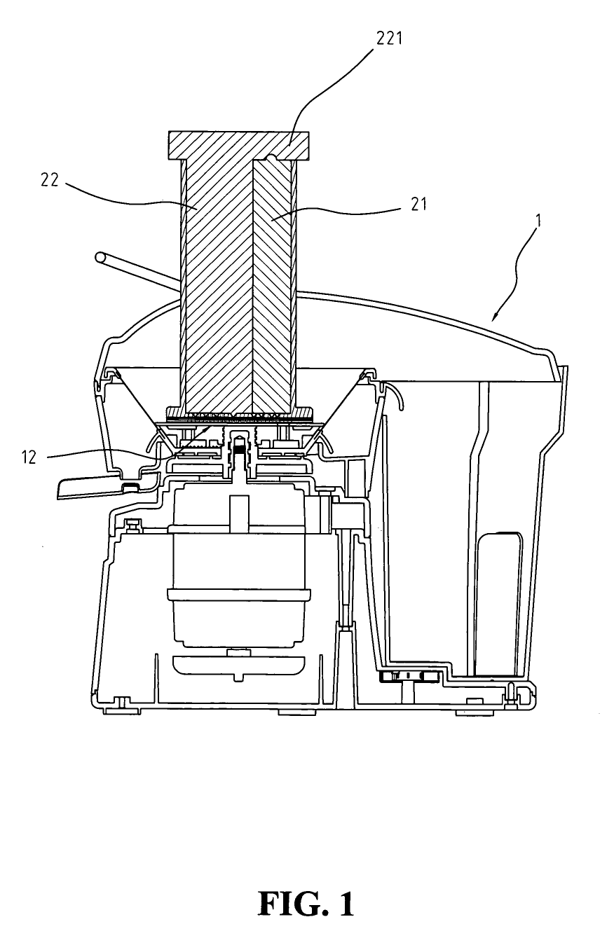

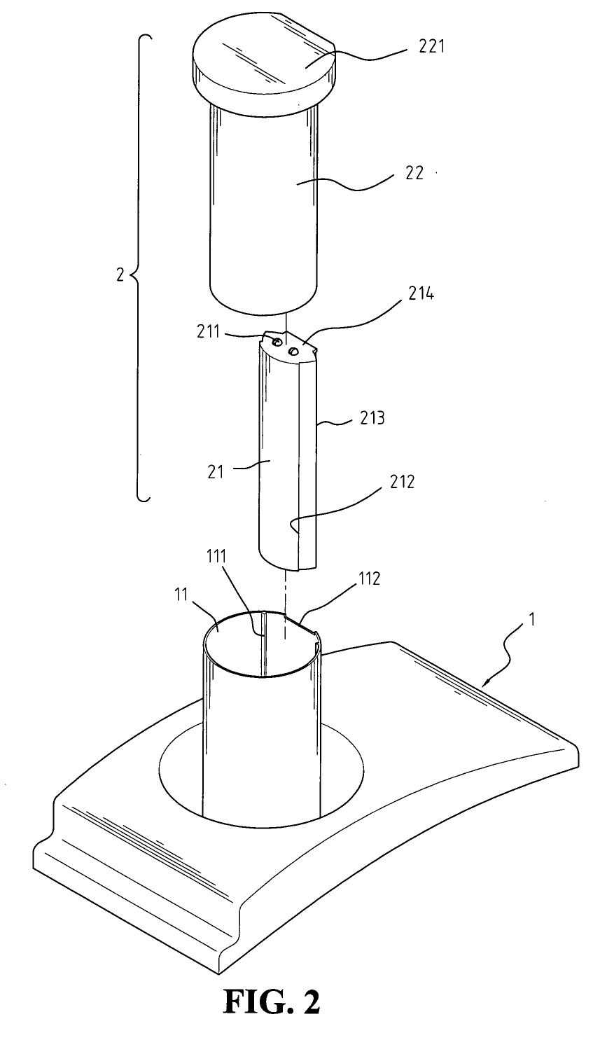

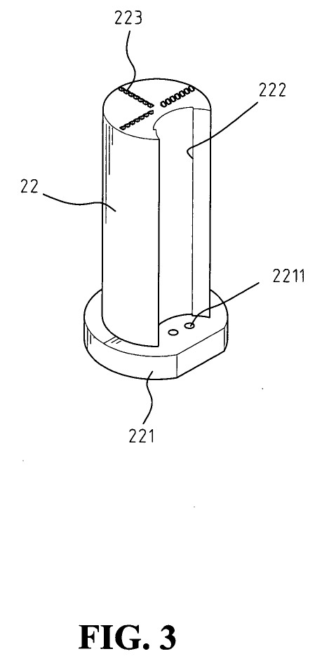

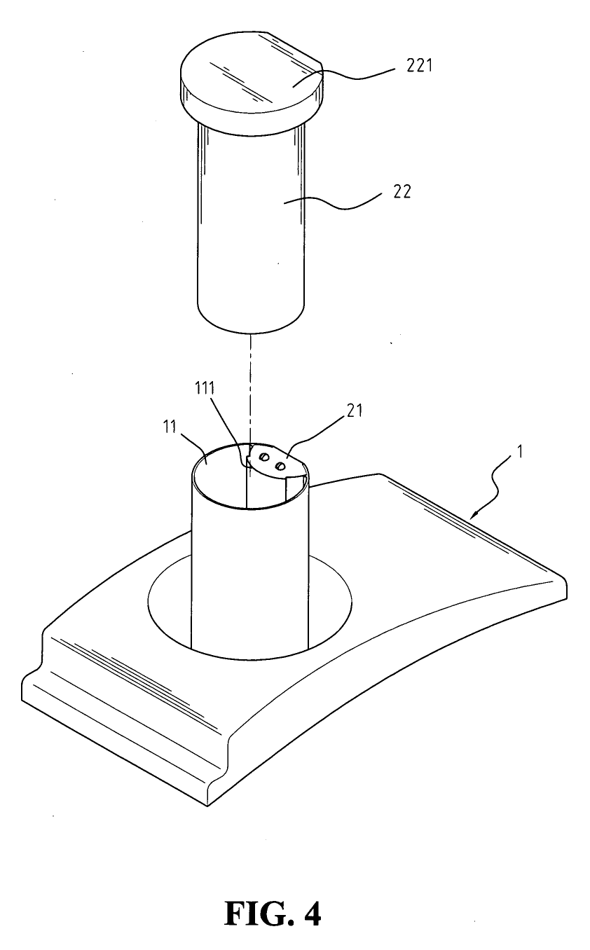

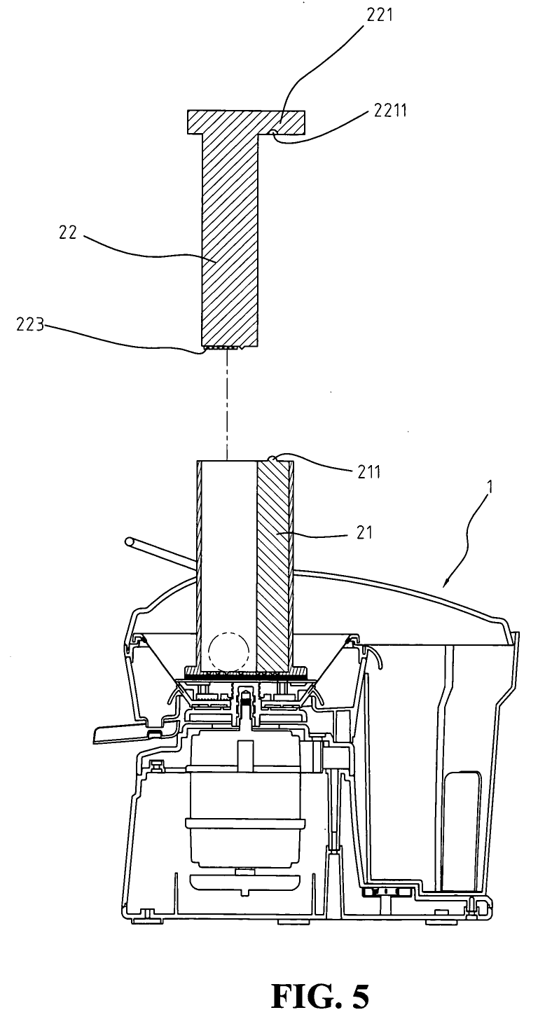

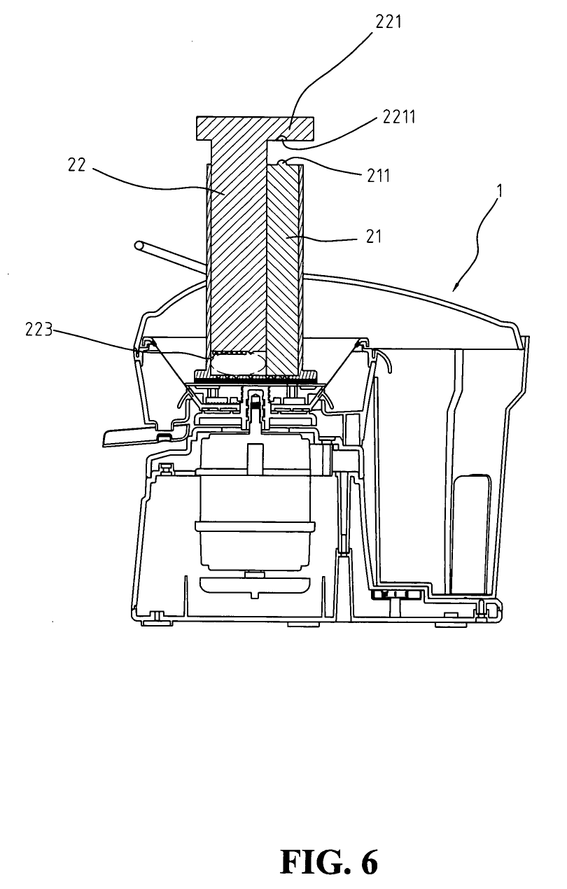

Referring to the drawings and in particular FIGS. 1 to 6, a juice extruder 1 comprises a case with a motor received therein and a blade set 12 driven by the motor. A tubular inlet 11 is defined in a top of the case 1 and communicates with the blade set 12.

A pusher 2 includes a first part 21 connected to an inner periphery of the inlet 11 and a second part 22. The second part 22 has a crescent-shaped cross section and the second part 22 is shaped to be complimentary to the cross section of the first part 21. A first rail mechanism is located between the first part 21 and the inner periphery of the inlet 11 so that the first part 21 is connected to the inner periphery of the inlet 11 and is not rotated in the inlet 11. Two axial guide plates 111 extend from an inner periphery of the inlet 11 and the first part 21 includes two axial side surfaces 213 which are engaged with the two guide plates 111 so that the first part 21 is connected to the inner periphery of the inlet 11. A flat outside 112 is defined in the outer periphery of the inlet 11 and a protrusion 214 extends radially from a top end of the first part 21 so as to be engaged with the flat outside 112. The protrusion 214 allows the user to easily remove the first part 21 from the inlet 11 when cleaning. It is noted that the lower end of the first part 21 is located close to the center of the blade set 12.

The second part 22 has a part of an outer periphery thereof being shaped to be complimentary to a part of an outer periphery of the first part 21 so that the second part 22 is movably inserted into the rest of space of inlet 11. A second rail mechanism is located between the first part 21 and the second part 22, wherein two axial convex ridges 212 are on the first part 21 and two axial grooves 222 are defined in the second part 22, so that the convex ridges 212 of the first part 21 are engaged with the groves 222 when the second part 22 is inserted into the inlet 11. The second part 22 has a plurality of teeth 223 defined in a lower end thereof so that when the fruit is ground by the rotating blade set 12, the teeth 223 provide friction to keep the fruit at position so as to be completely ground rather than co-rotated with the blade set 12.

The second part 22 has a head 221 extending radially from a top end thereof and a plurality of notches 2211 are defined in an underside of the head 221. The first part 21 has a plurality of bosses 211 defined in the top end thereof so that the bosses 211 are engaged with the notches 2211 when the second part 22 is inserted into the inlet 11 and the head 221 is mounted on the top end of the first part 21.

The fruit is put into the inlet 11 where the first part 21 is located therein and the lower end of the first part 21 is located close to the center of the blade set 12 so that the fruit can be sent to the blade set 12 away from the center. The second part 22 is inserted into the inlet 11 to push the fruit downward and the teeth 223 avoid the fruit from co-rotating with the blade set 12.

While we have shown and described the embodiment in accordance with the present invention, it should be clear to those skilled in the art that further embodiments may be made without departing from the scope of the present invention.

What is claimed is:

1. A juice extruder comprising:
a case with a motor received therein and a blade set driven by the motor, a
tubular inlet defined in the case, and
a pusher including a first part connected to an inner periphery of the inlet and a second part, the second part having a part of an outer periphery thereof being shaped to be complimentary to a part of an outer periphery of the first part, the second part movably inserted into the inlet.

2. The juice extruder as claimed in claim 1, wherein the second part has a plurality of teeth defined in a lower end thereof.

3. The juice extruder as claimed in claim 1, wherein the second part has a head extending radially from a top end thereof and a plurality of notches are defined in an underside of the head, the first part has a plurality of bosses defined in a top end thereof so that the bosses are engaged with the notches when the second part is inserted into the inlet and the head is mounted on the top end of the first part.

4. The juice extruder as claimed in claim 1, wherein a first rail mechanism located between the first part and the inner periphery of the inlet so that the first part is not rotated in the inlet.

5. The juice extruder as claimed in claim 3, wherein a first rail mechanism located between the first part and the inner periphery of the inlet so that the first part is not rotated in the inlet.

6. The juice extruder as claimed in claim 1, wherein the first part includes convex ridges and the second part has grooves with which the convex ridges are engaged.

7. The juice extruder as claimed in claim 5, wherein a second rail mechanism located between the first part and the second part.

8. The juice extruder as claimed in claim 7, wherein the second rail mechanism includes convex ridges on the first part and the grooves defined in the second part.

9. The juice extruder as claimed in claim 1, wherein the second part has a crescent-shaped cross section and the second part is shaped to be complimentary to the cross section of the first part.
